(19) United States
(12) Patent Application Publication
(10) Pub. No.: US 2024/0048377 A1
(43) Pub. Date: Feb. 8, 2024

(54) CIPHERTEXT CONVERSION SYSTEM, CONVERSION KEY GENERATION METHOD, AND NON-TRANSITORY COMPUTER READABLE MEDIUM

(71) Applicant: Mitsubishi Electric Corporation, Tokyo (JP)

(72) Inventor: Yutaka KAWAI, Tokyo (JP)

(73) Assignee: Mitsubishi Electric Corporation, Tokyo (JP)

(21) Appl. No.: 18/379,328

(22) Filed: Oct. 12, 2023

Related U.S. Application Data
(63) Continuation of application No. PCT/JP2021/018664, filed on May 17, 2021.

(51) Int. Cl. H04L 9/16; H04L 9/06

(52) U.S. Cl. CPC H04L 9/16; H04L 9/0637

(57) ABSTRACT

A ciphertext conversion system (100) includes a conversion key generation device (600). The conversion key generation device (600) includes a conversion destination selling unit and a conversion key generation unit. The conversion destination setting unit generates an attribute-based encryption key and an attribute-based ciphertext which is encrypted from the attribute-based encryption key, according to an attribute-based encryption scheme. The conversion key generation unit generates a conversion key which converts a first common-key ciphertext into a second common-key ciphertext being a ciphertext that matches a first common-key cryptography scheme and that is different from the first common-key ciphertext, on a basis of first common-key cryptographic information used when generating the first common-key ciphertext by encrypting, according to a first common-key cryptography scheme, a plaintext with a first secret key. The conversion key generation unit generates a third common-key ciphertext according to a second common-key cryptography scheme, by encrypting a second secret key used for decrypting the second common-key ciphertext, with the attribute-based encryption key.

### CROSS REFERENCE TO RELATED APPLICATION

This application is a Continuation of PCT International Application No. PCT/JP2021/018664, filed on May 17, 2021, which is hereby expressly incorporated by reference into the present application.

### TECHNICAL FIELD

The present disclosure relates to a ciphertext conversion system, a conversion key generation method, and a conversion key generation program.

### BACKGROUND ART

A Proxy Re-Encryption (PRE) scheme is a system in which decryption authority of a ciphertext is delegated to another person, instead of decrypting the ciphertext. Non-Patent Literature 1 discloses a PRE (Attribute-Based PRE, ABPRE) scheme in attribute-based encryption of an arbitrary scheme. By using the scheme disclosed in Non-Patent Literature 1, proxy re-encryption between different attribute-based encryptions is realized. Non-Patent Literature 2 discloses a technique for changing a key of common-key cryptography without decrypting a ciphertext of the common-key cryptography.

### CITATION LIST

### Non-Patent Literature

Non-Patent Literature 1: Zuoxia Vu et al., “Achieving Flexibility for ABE with Outsourcing via Proxy Re-Encryption”, ASIACCS' 18, Jun. 4-8, 2018, Session 16: Applied Crypto 2, pp. 659-672

Non-Patent Literature 2: Amril Syalim et. al, “Realizing Proxy Re-encryption in the Symmetric World”, ICIEIS (International Conference on Informatics Engineering and Information Science) 2011, Informatics Engineering and Information Science, pp. 259-274

### SUMMARY OF INVENTION

### Technical Problem

A typical proxy re-encryption scheme such as the technique disclosed in Non-Patent Literature 1 is a technique for converting a ciphertext of a certain public-key cryptography scheme into a ciphertext of another public-key cryptography scheme. The technique disclosed in Non-Patent Literature 2 is a technique for converting a ciphertext of common-key cryptography into a ciphertext of common-key cryptography.

When converting a ciphertext of a common-key cryptography scheme into a ciphertext based on a public-key cryptography scheme using prior art, there is no other choice but to decrypt the ciphertext of the common-key cryptography scheme once to acquire a plaintext, and after that to encrypt the plaintext acquired by the public-key cryptography scheme. This poses a problem that since the plaintext is exposed, security is low.

An objective of the present disclosure is to convert a ciphertext encrypted by a common-key cryptography scheme into a ciphertext based on a public-key cryptography scheme, instead of decrypting the ciphertext encrypted by the common-key cryptography scheme.

### Solution to Problem

A ciphertext conversion system according to the present disclosure includes:

a conversion key generation device including

a conversion destination setting unit to generate an attribute-based encryption key and an attribute-based ciphertext which is encrypted from the attribute-based encryption key, according to an attribute-based encryption scheme; and

a conversion key generation unit

to generate a conversion key which converts a first common-key ciphertext into a second common-key ciphertext being a ciphertext that matches a first common-key cryptography scheme and that is different from the first common-key ciphertext, on a basis of first common-key cryptographic information used when generating the first common-key ciphertext by encrypting, according to the first common-key cryptography scheme, a plaintext with a first secret key, and

to generate a third common-key ciphertext according to a second common-key cryptography scheme, by encrypting a second secret key used for decrypting the second common-key ciphertext, with the attribute-based encryption key.

### Advantageous Effects of Invention

In the present disclosure, an attribute-based ciphertext is a ciphertext of a public-key miptography scheme. A third common-key ciphertext is a ciphertext obtained by encrypting a second secret key with an attribute-based encryption key used to generate the attribute-based ciphertext. Here, the second secret key is used to decrypt a second common-key ciphertext. Hence, the second common-key ciphertext is a ciphertext based on the public-key cryptography scheme. Further, a first common-key ciphertext is a ciphertext encrypted by a first common-key cryptography scheme which is a common-key cryptography scheme. The second common-key ciphertext is a ciphertext obtained by converting the first common-key ciphertext with using a conversion key. When converting the first common-key ciphertext into the second common-key ciphertext, it is not necessary to decrypt the first common-key ciphertext.

Therefore, according to the present disclosure, it is possible to convert a ciphertext encrypted by a common-key cryptography scheme into a ciphertext based on a public-key cryptography scheme without decrypting the ciphertext encrypted by the common-key cryptography scheme.

### BRIEF DESCRIPTION OF DRAWINGS

FIG. 1 is a diagram illustrating a configuration example of a ciphertext conversion system 100 according to Embodiment 1.

FIG. 2 is a diagram illustrating a configuration example of a common-key cryptography secret key generation device 200 according to Embodiment 1.

FIG. 3 is a diagram illustrating a configuration example of a parameter generation device 300.

FIG. 4 is a diagram illustrating a configuration example of a user secret key generation device 400 according to Embodiment 1.

FIG. 5 is a diagram illustrating a configuration example of a common-key ciphertext generation device 500 according to Embodiment 1.

FIG. 6 is a diagram illustrating a configuration example of a conversion key generation device 600 according to Embodiment 1.

FIG. 7 is a diagram illustrating a configuration example of a conversion device 700 according to Embodiment 1.

FIG. 8 is a diagram illustrating a configuration example of a decryption device 800 according to Embodiment 1.

FIG. 9 is a diagram illustrating a hardware configuration example of each device the ciphertext conversion system 100 according to Embodiment 1 is provided with.

FIG. 10 is a flowchart illustrating operations of the common-key cryptography secret key generation device 200 according to Embodiment 1.

FIG. 11 is a flowchart illustrating operations of the parameter generation device 300 according to Embodiment 1.

FIG. 12 is a flowchart illustrating operations of the user secret key generation device 400 according to Embodiment 1.

FIG. 13 is a flowchart illustrating operations of the common-key ciphertext generation device 500 according to Embodiment 1.

FIG. 14 is a flowchart illustrating operations of the conversion key generation device 600 according to embodiment 1.

FIG. 15 is a flowchart illustrating operations of the conversion device 700 according to Embodiment 1.

FIG. 16 is a flowchart illustrating operations of the decryption device 800 according to Embodiment 1.

FIG. 17 is a diagram illustrating a hardware configuration diagram of each device a ciphertext conversion system 100 according to a modification of Embodiment 1 is provided with.

### DESCRIPTION OF EMBODIMENTS

In description and drawings of the embodiment, the same elements and equivalent elements are denoted by the same reference sign. Description of elements denoted by the same reference sign will appropriately be omitted or simplified. Arrows in the drawings mainly indicate data flows or process flows. Note that a term “unit” or “device” may be appropriately replaced by “circuit”, “method”, “stage”, “procedure”, “process”, or “circuitry”.

### Embodiment 1

The present embodiment will be described below in detail with referring to drawings.

### Description of Configurations

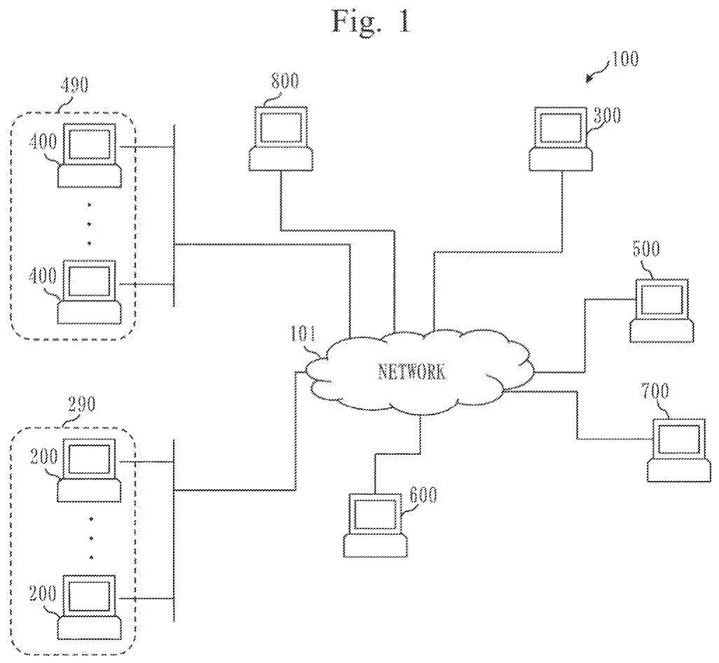

FIG. 1 is a block diagram illustrating a configuration example of a ciphertext conversion system 100 according to the present embodiment.

As illustrated in FIG. 1, a ciphertext conversion system 100 is provided with a common-key cryptography secret key generation device group 290 consisting of a plurality of common-key cryptography secret key generation devices 200, a parameter generation device 300, a user secret key generation device group 490 consisting of a plurality of user secret key generation devices 400, a common-key ciphertext generation device 500, a conversion key generation device 600, a conversion device 700, and a decryption device 800. The devices the ciphertext conversion system 100 is provided with are each a computer, and a specific example of the computer is a Personal Computer (PC). At least two devices out of the devices the ciphertext conversion system 100 is provided with may be each constituted of one computer.

A network 101 is a communication path to connect the devices the ciphertext conversion system 100 is provided with. A specific example of the network 101 is the Internet, or may alternatively be a different type of network.

The devices the ciphertext conversion system 100 is provided with need not be connected via the network 101 but may be placed in a Local Area Network (LAN) laid in a certain facility.

The common-key cryptography secret key generation device 200 generates a common-key cryptography secret key and transmits the generated common-key cryptography secret key to the common-key ciphertext generation device 500 and the conversion key generation device 600.

The parameter generation device 300 is a computer which generates a common parameter to be employed in the ciphertext conversion system 100 and which transmits the generated common parameter to the plurality of user secret key generation devices 400, the conversion key generation device 600, the conversion device 700, and the decryption device 800 via the network 101. Note that the common parameter may be transmitted directly by mailing or the like instead of via the network 101.

The user secret key generation device 400 generates a user secret key and transmits the generated user secret key to the decryption device 800.

The common-key ciphertext generation device 500 functions as a data encryption device. The common-key ciphertext generation device 500 receives the common-key cryptography secret key from the common-key cryptography secret key generation device 200, and takes a plaintext M as input. Using the common-key cryptography secret key and the plaintext M, the common-key ciphertext generation device 500 generates a common-key ciphertext skC and ciphertext auxiliary information auxC, and outputs the generated common-key ciphertext skC and ciphertext auxiliary information auxC.

The conversion key generation device 600 receives a public key from the parameter generation device 300, the common-key cryptography secret key from the common-key cryptography secret key generation device 200, and ciphertext auxiliary information from the common-key ciphertext generation device 500, and takes a decryptability condition L as input. Using the public key, the common-key cryptography secret key, and the ciphertext auxiliary information, the conversion key generation device 600 generates a conversion key ck, and outputs the generated conversion key ck. The decryptability condition L is a condition that expresses, with a logical formula, a user capable of decrypting a post-conversion ciphertext.

The conversion device 700 receives the conversion key from the conversion key generation device 600 and the common-key ciphertext from the common-key ciphertext generation device 500. Using the conversion key and the common-key ciphertext, the conversion device 700 generates a post-conversion common-key cipher skC′ and a post-conversion public-key ciphertext pkC, and outputs the generated post-conversion common-key ciphertext skC′ and post-conversion public-key ciphertext pkC to the decryption device 800.

The decryption device 800 receives the post-conversion common-key ciphertext (skC′, auxC′) and the post-conversion public-key ciphertext pkC from the conversion device 700 and the user secret key from the user secret key generation device 400. Decrypting the ciphertext by using the received user secret key, the decryption device 800 outputs a decryption result obtained.

A configuration of the present embodiment will be described below.

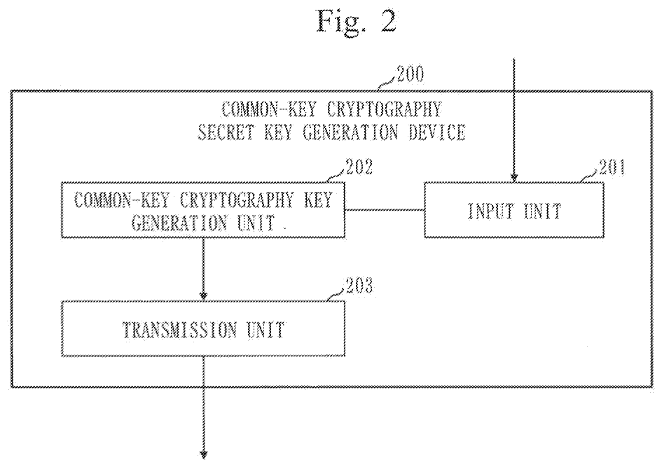

FIG. 2 is a block diagram illustrating a configuration example of the common-key cryptography secret key generation device 200.

As illustrated in FIG. 2, the common-key cryptography secret key generation device 200 is provided with an input unit 201, a common-key cryptography key generation unit 202, and a transmission unit 203.

Although not illustrated, the common-key cryptography secret key generation device 200 is provided with a recording medium which stores data to be used in the individual units in the common-key cryptography secret key generation device 200.

The input unit 201 accepts input of a bit length of a key employed in the present system.

The common-key cryptography key generation unit 202 generates a common-key cryptography secret key sk being a basis of computation employed in the ciphertext conversion system 100. Although not illustrated, the common-key cryptography key generation unit 202 may be provided with a random-number generation function or the like to generate the common-key cryptography secret key sk.

The transmission unit 203 transmits the common-key cryptography secret key sk generated by the common-key cryptography key generation unit 202 to each of the common-key ciphertext generation device 500 and the conversion key generation device 600.

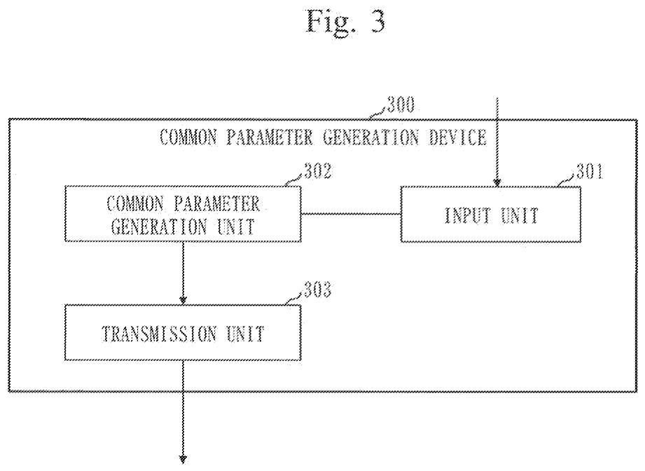

FIG. 3 is a block diagram illustrating a configuration example of the common parameter generation device 300.

As illustrated in FIG. 3, the common parameter generation device 300 is provided with an input unit 301, a common parameter generation unit 302, and a transmission unit 303.

Although not illustrated, the common parameter generation device 300 is provided with a recording medium which stores data to be used in the individual units in the common parameter generation device 300.

The input unit 301 accepts input of a bit length of the key employed in the ciphertext conversion system 100.

The common parameter generation unit 302 generates each of a public key pk and a master secret key msk which are employed in computation executed by the ciphertext conversion system 100. Although not illustrated, the common parameter generation unit 302 may be provided with a random-number generation function or the like to generate each of the public key pk and the master secret key rusk.

The transmission unit 303 transmits the public key pk generated by the common parameter generation unit 302 to each of the conversion key generation device 600 and the conversion device 700. The transmission unit 303 also transmits the master secret key msk to each of the plurality of user secret key generation devices 400.

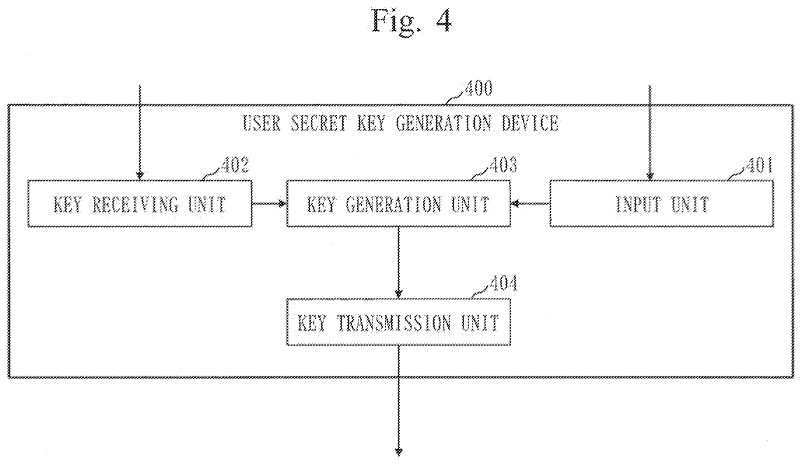

FIG. 4 is a block diagram illustrating a configuration example of the user secret key generation device 400. As illustrated in FIG. 4, the user secret key generation device 400 is provided with an input unit 401, a key receiving unit 402, a key generation unit 403, and a key transmission unit 404.

Although not illustrated, the user secret key generation device 400 is provided with a recording medium which stores data to be used in the individual units in the user secret key generation device 400.

The input unit 401 accepts an attribute parameter Γ as input.

The key receiving unit 402 receives the master secret key msk.

The key generation unit 403 generates a user secret key skr. Although not illustrated, the key generation unit 403 may be provided with a random-number generation function or the like to generate the user secret key skr.

The key transmission unit 404 transmits the user secret key skr generated by the key generation unit 403 to the decryption device 800.

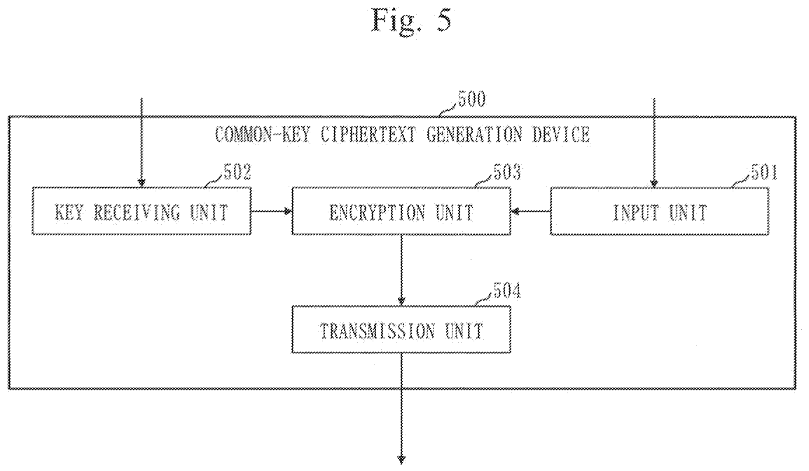

FIG. 5 is a block diagram illustrating a configuration example of the common-key ciphertext generation device 500. As illustrated in FIG. 5, the common-key ciphertext generation device 500 is provided with an input unit 501, a key receiving unit 502, an encryption unit 503, and a transmission unit 504.

Although not illustrated, the common-key ciphertext generation device 500 is provided with a recording medium which stores data to be used in the individual units in the common-key ciphertext generation device 500.

The input unit 501 accepts the plain text M as input.

The key receiving unit 502 receives the common-key cryptography secret key sk.

The encryption unit 503 generates the common-key ciphertext skC and the auxiliary information auxC. Although not illustrated, the encryption unit 503 may be provided with a random-number generation function or the like to generate the common-key ciphertext skC. The encryption unit 503 generates a first common-key ciphertext.

The transmission unit 504 transmits the common-key ciphertext skC to the conversion device 700 and the auxiliary information auxC to the conversion key generation device 600.

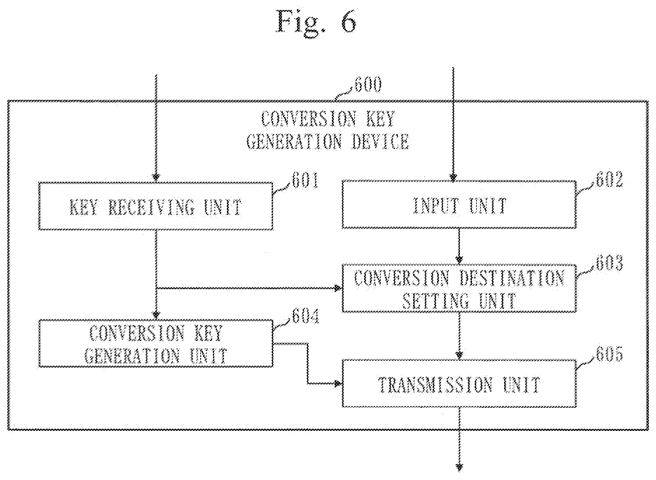

FIG. 6 is a block diagram illustrating a configuration example of the conversion key generation device 600.

As illustrated in FIG. 6, the conversion key generation device 600 is provided with a key receiving unit 601, an input unit 602, a conversion destination setting unit 603, a conversion key generation unit 604, and a transmission unit 605.

Although not illustrated, the conversion key generation device 600 is provided with a recording medium which stores data to be used in the individual units in the conversion key generation device 600.

The key receiving unit 601 receives each of the public key pk, the common-key cryptography secret key sk, and the auxiliary information auxC.

The input unit 602 accepts the decryptability condition L from the outside as input.

The conversion destination setting unit 603 generates a public-key ciphertext P being part of the conversion key, from the public key pk received by the key receiving unit 601 and the dectyptability condition L inputted by the input unit 602. The conversion destination setting unit 603 generates an attribute-based encryption key and an attribute-based ciphertext which is encrypted from the attribute-based encryption key, according to an attribute-based encryption scheme.

The conversion key generation unit 604 generates S being part of the conversion key, from the common-key cryptography secret key sk and the auxiliary information auxC which are received by the key receiving unit 601. The conversion key generation unit 604 generates a conversion key which converts the first common-key ciphertext into a second common-key ciphertext being a ciphertext that matches a first common-key cryptography scheme and that is different from the first common-key ciphertext, on a basis of first common-key cryptographic information used when generating the first common-key ciphertext by encrypting, according to the first common-key cryptography scheme, a plaintext with a first secret key. The conversion key generation unit 604 generates a third common-key ciphertext according to a second common-key cryptography scheme, by encrypting a second secret key used for decrypting the second common-key ciphertext, with the attribute-based encryption key. A specific example of the first common-key cryptography scheme is a block-cipher counter mode scheme. The first common-key cryptographic information may consist of the first secret key, and first auxiliary information which is used in encryption according to the block-cipher counter mode scheme. The conversion key generation unit 604 may generate the conversion key with using the first common-key cryptographic information, and second common-key cryptographic information which consists of the second secret key and second auxiliary information which are used in encryption according to the block-cipher counter mode scheme. The conversion key generation unit 604 may calculate, as the conversion key, an exclusive OR of a result of execution of the first common-key cryptography scheme with using the first common-key cryptographic information and a result of execution of the first common-key cryptography scheme with using the second common-key cryptographic information.

Although not illustrated, each of the conversion destination setting unit 603 and the conversion key generation unit 604 may be provided with a random-number generation function or the like to generate the conversion key.

The transmission unit 605 integrates generated conversion keys and outputs an integrated conversion key to the conversion device 700 as the conversion key ck (=(P, S)).

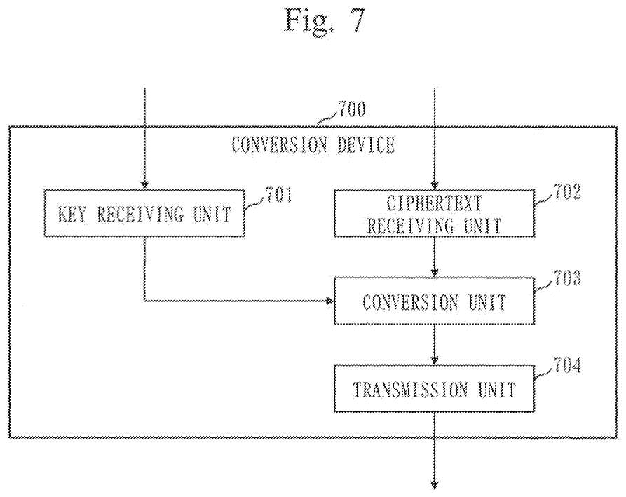

FIG. 7 is a block diagram illustrating a configuration example of the conversion device 700. As illustrated in FIG. 7, the conversion device 700 is provided with a key receiving unit 701, a ciphertext receiving unit 702, a conversion unit 703, and a transmission unit 704.

Although not illustrated, the conversion device 700 is provided with a recording medium which stores data to be used in the individual units in the conversion device 700.

The key receiving unit 701 receives each of the public key pk and the conversion key ck.

The ciphertext receiving unit 702 receives the common-key ciphertext skC.

The conversion unit 703 converts the common-key ciphertext skC with using part of the conversion key ck, thereby converting the common-key ciphertext skC into the post-conversion common-key ciphertext skC′. The post-conversion common-key ciphertext skC′ is a ciphertext under the decryptability condition being set concerning the public-key ciphertext P. The conversion unit 703 also generates the post-conversion public-key ciphertext pkC with using part of the conversion key ck. The conversion unit 703 calculates, as the second common-key ciphertext, an exclusive OR of the first common-key ciphertext and the conversion key.

The transmission unit 704 outputs the post-conversion public-key ciphertext pkC and the post-conversion common-key ciphertext (skC′, auxC′) to the decryption device 800.

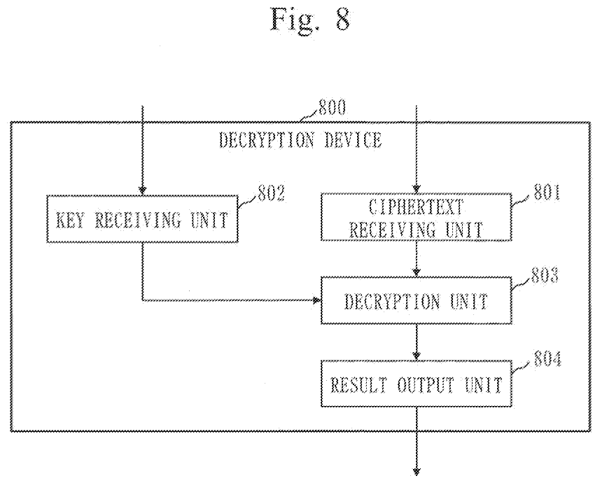

FIG. 8 is a block diagram illustrating a configuration example of the decryption device 800. As illustrated in FIG. 8, the decryption device 800 is provided with a ciphertext receiving unit 801, a key receiving unit 802, a decryption unit 803, and a result output unit 804.

The ciphertext receiving unit 801 receives each of the post-conversion public-key ciphertext pkC and the post-conversion common-key ciphertext (skC′, auxC′).

The key receiving unit 802 receives the user secret key ski from the user secret key generation device 400.

The decryption unit 803 calculates the plaintext M by executing a decryption process. In a specific example of the deception process, first, the decryption unit 803 decrypts the attribute-based ciphertext with using the user secret key that matches attribute information corresponding to the attribute-based encryption key, thereby acquiring the attribute-based encryption key. Next, the decryption unit 803 decrypts the third common-key ciphertext with using the acquired attribute-based encryption key, thereby acquiring the second secret key. Next, the decryption unit 803 finds, as a plaintext corresponding to the acquired second common-key ciphertext, an exclusive OR of a result of encrypting the second auxiliary information with using the second secret key, and the second common-key ciphertext.

The result output unit 804 outputs the plaintext M.

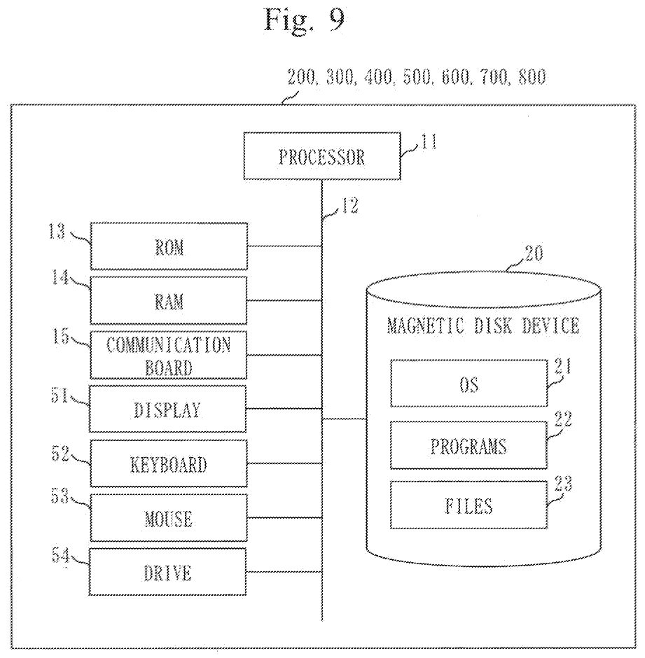

FIG. 9 is a diagram illustrating an example of hardware resources of each device the ciphertext conversion system 100 according to the present embodiment is provided with. Each device the ciphertext conversion system 100 is provided with may be constituted of a plurality of computers.

Each device provided to the ciphertext conversion system 100 is equipped with a processor 11 (Central Processing Unit). The processor 11 is connected to hardware devices such as a Read-Only Memory (ROM) 13, a Random-Access Memory (RAM) 14, a communication board 15, a display 51 (display device), a keyboard 52, a mouse 53, a drive 54, and a magnetic disk device 20 via a bus 12, and controls these hardware devices. The drive 54 is a device that reads from and writes on a storage medium such as a Flexible Disk Drive (FD), a Compact Disc (CD), and a Digital Versatile Disc (DVD).

The processor 11 is an Integrated Circuit (IC) which performs computation processing. A specific example of the processor 11 is a Central Processing Unit (CPU), a Digital Signal Processor (DSP), or a Graphics Processing Unit (GPU). Each device provided to the ciphertext conversion system 100 may be equipped with a plurality of processors that substitute for the processor 11. The plurality of processors share roles of the processor 11.

The ROM 13, the RAM 14, the magnetic disk device 20, and the drive 54 are each an example of a storage device. The keyboard 52, the mouse 53, and the communication board 15 are each an example of an input device. The display 51 and the communication board 15 are each an example of an output device.

The communication board 15 is connected to a communication network such as a Local Area Network (LAN), the Internet, and a telephone line via a wire or in a wireless manner. In a specific example, the communication board 15 is constituted of a communication chip or a Network Interface Card (NIC).

An Operating System (OS) 21, programs 22, and files 23 are stored in the magnetic disk device 20. A specific example of the magnetic disk device 20 is a Hard Disk Drive (HDD). Alternatively, the magnetic disk device 20 may be a flash memory or the like.

The programs 22 include programs that execute functions described as the individual units in the present embodiment. A specific example of the program is a data search program or a data registration program. The program is read and run by the processor 11. That is, the program causes the computer to function as a unit, and causes the computer to execute a procedure or method of the unit. Any program described in the present specification may be recorded on a computer-readable nonvolatile recording medium. A specific example of the nonvolatile recording medium is an optical disk or a flash memory. Any program described in the present specification may be provided as a program product.

The files 23 include data to be used in the individual units described in the present embodiment. In a specific example, the relevant data consists of input data, output data, a determination result, a calculation result, and a processing result.

### Description of Operations

An operation procedure of the ciphertext conversion system 100 corresponds to a ciphertext conversion method. A program that implements operations of the ciphertext conversion system 100 corresponds to a ciphertext conversion program. An operation procedure of a device provided to the ciphertext conversion system 100 corresponds to a method including, in its name, a name of that device provided to the ciphertext conversion system 100. In a specific example, an operation procedure of the conversion key generation device 600 corresponds to a conversion key generation method. A program that implements operations of a device provided to the ciphertext conversion system 100 corresponds to a program including, in its name, a name of that device provided to the ciphertext conversion system 100. In a specific example, a program that implements operations of the conversion key generation device 600 corresponds to a conversion key generation program.

Below, the operations of the ciphertext conversion system 100 which correspond to a calculation method of each device according to the present embodiment will be described.

Prior to description of the operations of the ciphertext conversion system 100, a basic cryptographic technique used in the present embodiment and notation employed in the relevant cryptographic technique will be described.

An attribute-based encryption scheme is a cryptographic technique according to which decryption is possible only to a user possessing a user secret key generated from an attribute parameter Γ that satisfies a decryption condition being set with the decryptability condition L. The attribute parameter Γ is also an attribute set. The attribute-based encryption scheme is constituted of an algorithm as follows.

First, setup ABESETUP, a key length, and so on are taken as input, and the master secret key msk and the public key pk are outputted. Next, user secret key generation ABEKEYGEN, the master secret key msk, and the attribute parameter Γ are taken as input, and the user secret key sky that matches the attribute parameter Γ is generated. Next, encryption ABEENC, the public key pk, and the decryptability condition L are taken as input, and a key K for common-key cryptography and the public-key ciphertext P that matches the key K are generated. Next, decryption ABEDEC, the user secret key skr, and the public-key ciphertext P are taken as input, and when the attribute parameter Γ corresponding to the user secret key skr and the decryptability condition L for generation of the public-key ciphertext P match, the key K from which the public-key ciphertext P is encrypted is outputted.

Common-key cryptography is a cryptographic technique to encrypt the plaintext M by using the common-key cryptography secret key sk and to decrypt a cipher by using the common-key cryptography secret key sk. When the common-key cryptography secret key sk is a random value, encryption SKEENC takes the common-key cryptography secret key sk and the plaintext M as input and outputs a ciphertext C corresponding to the relevant input. Decryption SKEDEC takes the common-key cryptography secret key sk and the ciphertext C as input and outputs the plaintext M corresponding to the relevant input.

The present embodiment employs, of the common-key cryptography, counter-mode encryption and counter-mode decryption that use a block cipher. Relevant encryption will be described as SCTRENC, and relevant decryption will be described as SCTRDEC. In the counter mode, a counter value exists as auxiliary information, and encryption and decryption are executed as follows. In the present specification, + signifies an exclusive OR unless otherwise noted.

[Encryption]

C=SCTRENC(sk, auxC)+M

[Decryption]

M=SCTRDEC(sk, auxC)+C

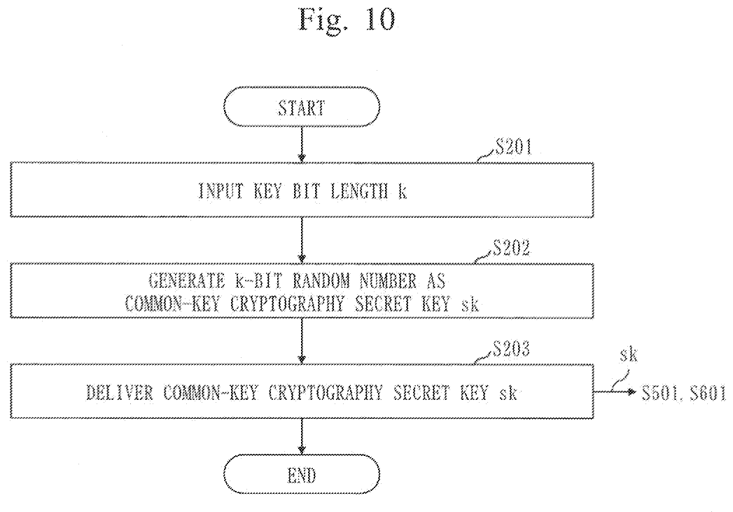

FIG. 10 is a flowchart illustrating an example of a common-key cryptography secret key generation step. The common-key cryptography secret key generation step will be described with referring to FIG. 10.

(Step S201: Information Input Step)

The input unit 201 accepts as input a key bit length k.

(Step S202: Secret Key Generation Step)

The common-key cryptography key generation unit 202 generates a k-bit random number and treats the generated random number as the common-key cryptography secret key sk.

(Step S203: Delivery Step)

The transmission unit 203 outputs the common-key cryptography secret key sk to the conversion key generation device 600.

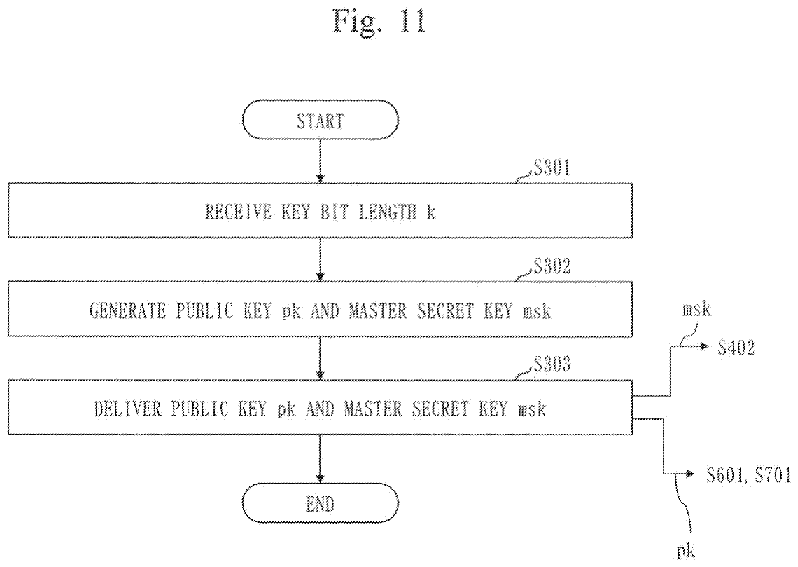

FIG. 11 is a flowchart illustrating an example of a parameter generation step. The parameter generation step will be described with referring to FIG. 11.

(Step S301: Information Input Step)

The input unit 301 accepts as input the key bit length k.

(Step S302: Key Generation Step)

The common parameter generation unit 302 executes setup Setup of attribute-based encryption to generate each of the master secret key msk and the public key pk.

(Step S303: Delivery Step)

The transmission unit 303 transmits each of the master secret key msk and the public key pk to the devices as necessary.

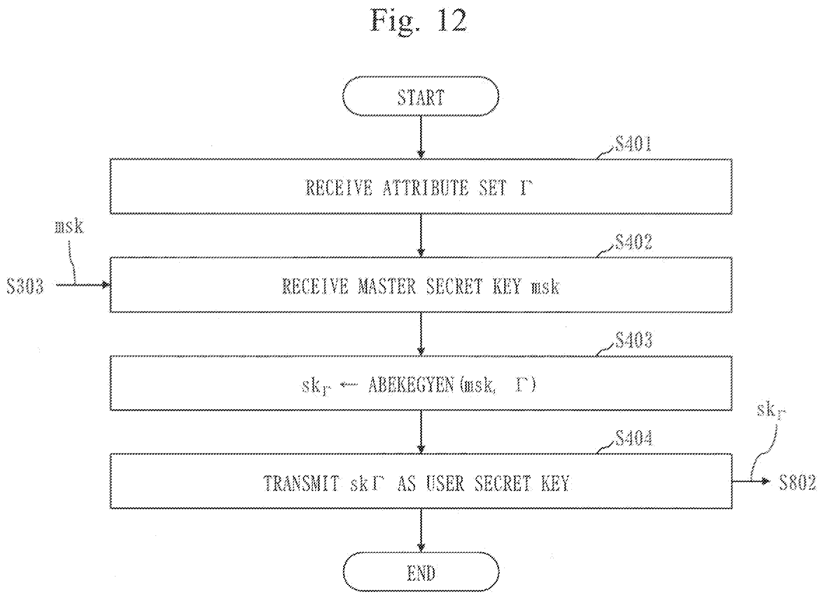

FIG. 12 is a flowchart expressing an example of a user secret key generation step. The user secret key generation step will be described with referring to FIG. 12.

(Step S401: Attribute Input Step)

The input unit 401 accepts the attribute parameter Γ as input.

(Step S402: Master Key Input Step)

The key receiving unit 402 receives the master secret key msk.

(Step S403: User Secret Key Generation Step)

The key generation unit 403 executes user secret key generation KeyGen of the attribute-based encryption with using the attribute parameter Γ and the master secret key msk, thereby generating the user secret key sky.

(Step S404: Transmission Step)

The key transmission unit 404 transmits the generated user secret key skr to the decryption device 800.

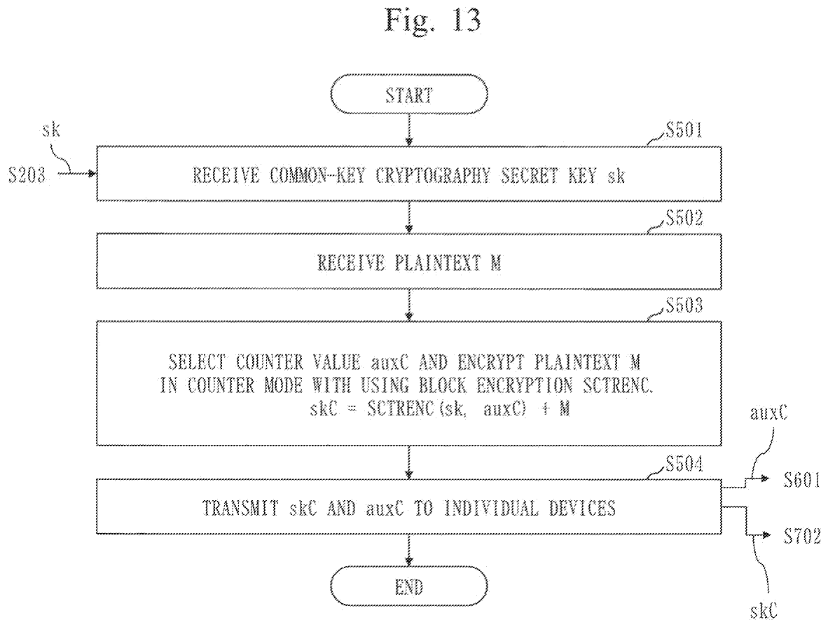

FIG. 13 is a flowchart expressing an example of a common-key ciphertext generation step. The common-key ciphertext generation step will be described with referring to FIG. 13.

(Step S501: Key Receiving Step)

The key receiving unit 502 receives the common-key cryptography secret key sk.

(Step S502: Plaintext Input Step).

The input unit 501 accepts the plaintext M as input.

(Step S503: Encryption Step)

The encryption unit 503 executes the block-cipher counter mode to encrypt the plaintext M. The encryption unit 503 takes a counter value in execution of the counter mode as the auxiliary information auxC and the ciphertext as the common-key ciphertext skC. A relationship between the auxiliary information auxC and the common-key ciphertext skC is described by [Formula 1]. The common-key ciphertext skC is equivalent to the first common-key ciphertext. SCTRENC is equivalent to encryption by the first common-key cryptography scheme. The common-key cryptography secret key sk is equivalent to the first secret key. The auxiliary information auxC is equivalent to the first auxiliary information. The common-key cryptography secret key sk and the auxiliary information auxC are equivalent to the first common-key cryptographic information.

skC=SCTRENC(sk, auxC)+M [Formula 1]

(Step S504: Transmission Step)

The transmission unit 504 transmits each of the common-key ciphertext skC and the auxiliary information auxC to the individual devices as necessary.

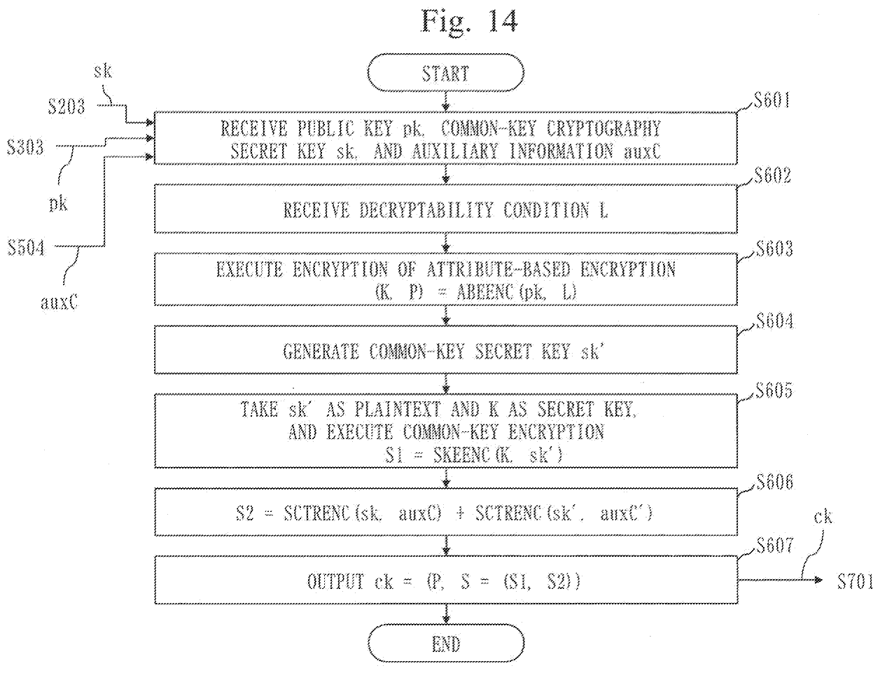

FIG. 14 is a flowchart expressing an example of a conversion key generation step. The conversion key generation step will be described with referring to FIG. 14.

(Step S601: Key Receiving Step)

The key receiving unit 601 receives each of the public key pk, the common-key cryptography secret key sk, and the auxiliary information auxC.

(Step S602: Input Step)

The input unit 602 accepts the decryptability condition L as input.

(Step S603: Conversion Destination Setting Step)

The conversion destination setting unit 603 executes encryption ABEENC of the attribute-based encryption on a basis of the public key pk and the decryptability condition L, as indicated by [Formula 2]. Note that the public-key ciphertext P is a post-conversion public-key ciphertext, and that the key K is a key from which the public-key ciphertext P is encrypted. The public-key ciphertext P is equivalent to the attribute-based ciphertext. The key K is equivalent to the attribute-based encryption key.

(K, P)=ABEENC(pk, L) [Formula 2]

(Step S604: Common-Key Secret Key Generation Step)

The conversion key generation unit 604 selects a new common-key cryptography secret key sk′.

(Step S605: Common-Key Secret Key Encryption Step)

The conversion key generation unit 604 takes the common-key cryptography secret key sk′ as the plaintext and the key K as the secret key, and executes common-key encryption as indicated by [Formula 3]. Note that S1 is equivalent to the third common-key ciphertext, SKEENC is equivalent to encryption according to the second common-key cryptography scheme, and sk′ is equivalent to the second secret key.

S1=SKEENC(K, sk′) [Formula 3]

(Step S606: Conversion Key Generation Step)

The conversion key generation unit 604 selects new auxiliary information auxC′ and executes computation indicated by [Formula 4] with using the selected new auxiliary information auxC′. The auxiliary information auxC′ is equivalent to the second auxiliary information. The common-key cryptography secret key sk′ and the auxiliary information auxC′ are equivalent to the second common-key cryptographic information.

S2=SCTRENC(sk, auxC)+SCTRENC(sk′, auxC′)

S=(S1, S2) [Formula 4]

(Step S607: Delivery Step)

The transmission unit 605 outputs the conversion key ck (=(P, S)) to the conversion device 700.

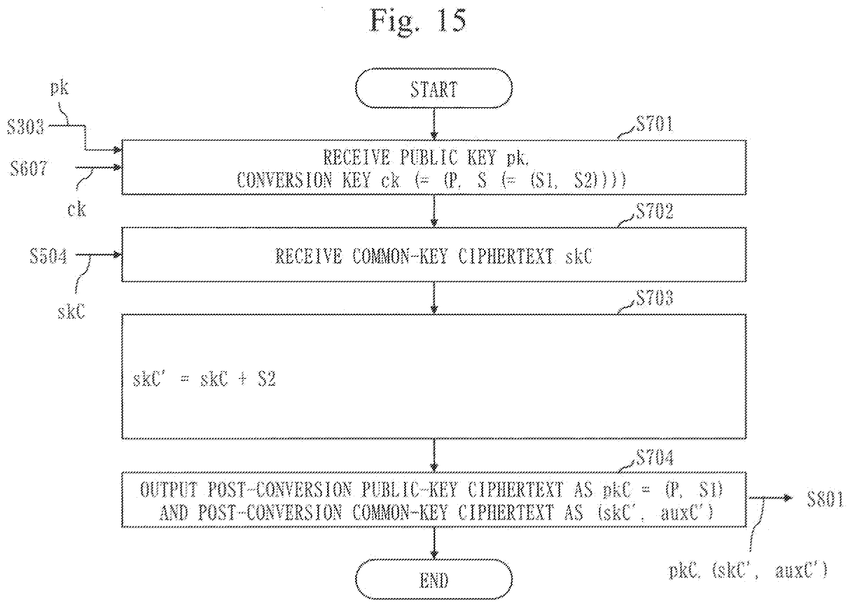

FIG. 15 is a flowchart expressing an example of a conversion step. The conversion step will be described with referring to FIG. 15.

(Step S701: Key Receiving Step)

The key receiving unit 701 receives the public key pk and the conversion key ck(=(P, S (=(S1, S2)))).

(Step S702: Input Step)

The ciphertext receiving unit 702 receives the common-key ciphertext skC.

(Step S703: Conversion Step)

The conversion unit 703 executes a calculation indicated by [Formula 5] with using the common-key ciphertext skC and S2. The post-conversion common-key ciphertext skC′ is equivalent to the second common-key ciphertext. Note that S2 is generated according to the first common-key cryptography scheme. Since the post-conversion common-key ciphertext skC′ is an exclusive OR of the common-key ciphertext skC and S2, the post-conversion common-key ciphertext skC′ matches the first common-key cryptography scheme.

skC′=skC+S2 [Formula 5]

Attention must be paid to the fact that a right side of [Formula 5] has a nature indicated by [Formula 6].

skC+S2=SCTRENC(sk, auxC)+M+SCTRENC(sk, auxC)+SCTRENC(sk′, auxC′)=SCTRENC(sk′, auxC′)+M [Formula 6]

(Step S704: Output Step)

The transmission unit 704 outputs the post-conversion public-key ciphertext to the decryption device 800 as pkC (=(P, S1)), and outputs the post-conversion common-key ciphertext to the decryption device 800 as (skC′, auxC′).

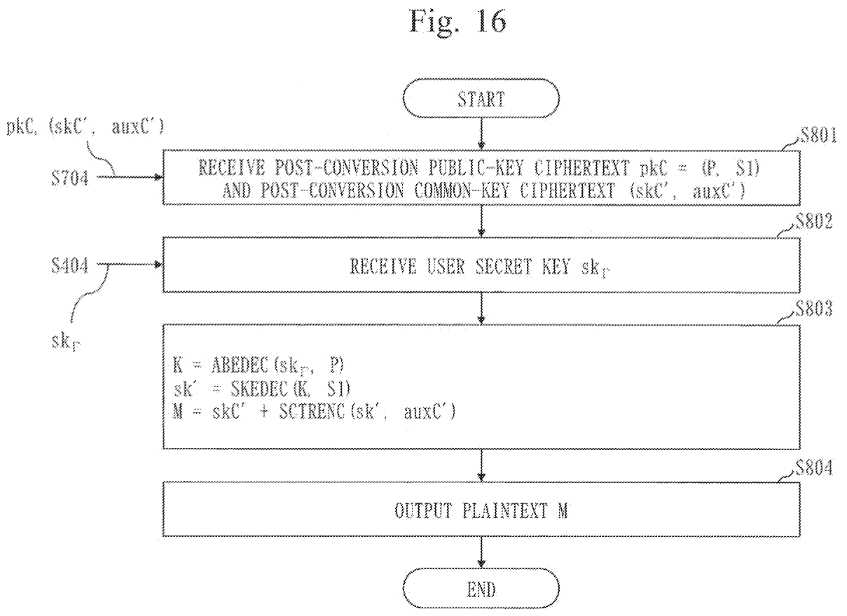

FIG. 16 is a flowchart expressing an example of a decryption step. The decryption step will be described with referring to FIG. 16.

(Step S801: Ciphertext Receiving Step)

The ciphertext receiving unit 801 receives the post-conversion public-key ciphertext pkC (=(P, S1)) and the post-conversion common-key ciphertext (skC′, auxC′).

(Step S802: Input Step)

The key receiving unit 802 receives the user secret key skr. The user secret key skr is equivalent to the user secret key that matches the attribute information corresponding to the attribute-based encryption key.

(Step S803: Decryption Processing Step)

The decryption unit 803 executes calculations indicated in [Formula 7] sequentially from the top with using received data, thereby decrypting the plaintext M. In [Formula 7], first, decryption of the attribute-based encryption is performed, so that the key K is decrypted. In [Formula 7], formulas that decrypt the plaintext M are formulas obtained from [Formula 5] and [Formula 6]. The plaintext M is a plaintext corresponding to the second common-key ciphertext.

K=ABEDEC(skr, P)

sk′=SKEDEC(K, S1)

M=skC′+SCTRENC(sk′, auxC′) [Formula 7]

(Step S804: Output Step)

The result output unit 804 outputs the plaintext M. In a specific example, the result output unit 804 outputs the plaintext M to a display provided to the decryption device 800.

### Description of Effect of Embodiment 1

As described above, according to the present embodiment, a user cannot calculate a sum of inner products unless a decryption key is acquired with using a decryption token, even if the user possesses a user secret key. Hence, information of a vector x linked to individual ciphertexts in prior art is not easy to analogize. Therefore, according to the present embodiment, the ciphertext conversion system 100 that is much safer can be realized.

Also, according to the present embodiment, a ciphertext encrypted by the common-key cryptography scheme can be converted to a ciphertext based on the public-key cryptography scheme, without a need of decrypting the cipher by any scheme such as the public-key cryptography scheme, a functional cryptography scheme with which an access range can be set, and the attribute-based encryption scheme. Therefore, according to the present embodiment, for example, conversion of a ciphertext encrypted by the common-key cryptography scheme into a ciphertext based on the public-key cryptography scheme, delivery of the converted ciphertext, and so on can be executed with using a resource-saving device that cannot execute computation of public-key encryption, and the like, leading to improvement of convenience.

### Other Configurations

### Modification 1

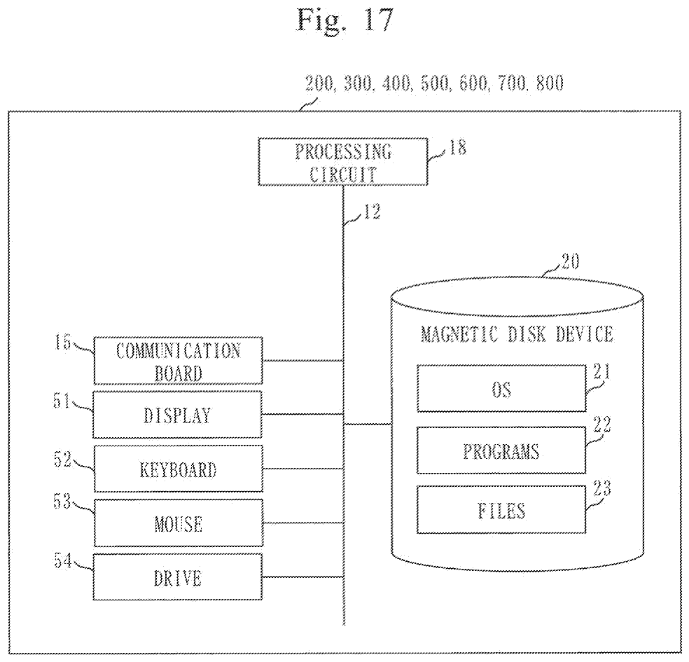

FIG. 17 illustrates a hardware configuration example of each device a ciphertext conversion system 100 according to the present modification is provided with.

Each device provided to the ciphertext conversion system 100 is equipped with a processing circuit 18 in place of: a processor 11; a processor 11 and a ROM 13; a processor 11 and a RAM 14; or a processor 11, a ROM 13, and a RAM 14.

The processing circuit 18 is hardware that implements at least some of the units provided to each device the ciphertext conversion system 100 is equipped with.

The processing circuit 18 may be dedicated hardware, or a processor that runs a program stored in the ROM 13 or the RAM 14.

When the processing circuit 18 is dedicated hardware, in a specific example, the processing circuit 18 is one out of or by a combination of a single circuit, a composite circuit, a programmed processor, a parallel-programmed processor, an Application Specific Integrated Circuit (ASIC), and a Field Programmable Gate Array (FPGA).

Each device the ciphertext conversion system 100 is equipped with may be provided with a plurality of processing circuits that substitute for the processing circuit 18. The plurality of processing circuits share roles of the processing circuit 18.

In each device the ciphertext conversion system 100 is equipped with, some of functions may be implemented by dedicated hardware, and remaining functions may be implemented by software or firmware.

In a specific example, the processing circuit 18 is implemented by one out of or by a combination of hardware, software, and firmware.

The processor 11, the ROM 13, the RAM 14, and the processing circuit 18 are collectively referred to as “processing circuitry”. That is, a function of each function constituent element of each device the ciphertext conversion system 100 is equipped with is implemented by processing circuitry.

### Other Embodiments

Having described Embodiment 1, a plurality of portions of the present embodiment may be practiced by combination. Alternatively, the present embodiment may be practiced partly. Various changes may be made to the present embodiment as necessary. The present embodiment may be practiced as a whole, or partly by any combination. Each unit disclosed in the present specification may be implemented by one out of or by a combination of firmware, software, and hardware.

The embodiment described above is an essentially preferred exemplification, and is not intended to limit the present disclosure, an application product of the present disclosure, and an application range of the present disclosure. Procedures described by using flowcharts or the like may be changed as necessary.

### REFERENCE SIGNS LIST

11: processor; 12: bus; 13: ROM; 14: RAM; 15: communication board; 18: processing circuit; 20: magnetic disk device; 21: OS; 22: programs; 23: files; 51: display; 52: keyboard; 53: mouse; 54: drive; 100: ciphertext conversion system; 101: network; 200: common-key cryptography secret key generation device; 201: input unit; 202: common-key cryptography key generation unit; 203: transmission unit; 290: common-key cryptography secret key generation device group; 300: parameter generation device; 301: input unit; 302: common parameter generation unit; 303: transmission unit; 400: user secret key generation device; 401: input unit; 402: key receiving unit; 403: key generation unit; 404: key transmission unit; 490: user secret key generation device group; 500: common-key ciphertext generation device; 501: input unit; 502: key receiving unit; 503: encryption unit; 504: transmission unit; 600: conversion key generation device; 601: key receiving unit; 602: input unit; 603: conversion destination setting unit; 604: conversion key generation unit; 605: transmission unit; 700: conversion device; 701: key receiving unit; 702: ciphertext receiving unit; 703: conversion unit; 704: transmission unit; 800: decryption device; 801: ciphertext receiving unit; $02: key receiving unit; 803: decryption unit; 804: result output unit; auxC, auxC′: auxiliary information; K: key; L: decryptability condition; M: plaintext; P: public-key ciphertext; ck: conversion key; pk: public key; pkC: post-conversion public-key ciphertext; msk: master secret key; sk, sk′: common-key cryptography secret key; skC: common-key ciphertext; skC′: post-conversion common-key ciphertext; skr: user secret key; Γ: attribute parameter.

1. A ciphertext conversion system comprising:
a conversion key generation device comprising
processing circuitry
to generate an attribute-based encryption key and an attribute-based ciphertext which is encrypted from the attribute-based encryption key, according to an attribute-based encryption scheme,
to generate a conversion key which converts a first common-key ciphertext into a second common-key ciphertext being a ciphertext that matches a first common-key cryptography scheme and that is different from the first common-key ciphertext, on a basis of first common-key cryptographic information used when generating the first common-key ciphertext by encrypting, according to the first common-key cryptography scheme, a plaintext with a first secret key, and
to generate a third common-key ciphertext according to a second common-key cryptography scheme, by encrypting a second secret key used for decrypting the second common-key ciphertext, with the attribute-based encryption key.

2. The ciphertext conversion system according to claim 1, wherein the first common-key cryptography scheme is a block-cipher counter mode scheme.

3. The ciphertext conversion system according to claim 2, wherein the first common-key cryptographic information consists of the first secret key and first auxiliary information which is used in encryption according to the block-cipher counter mode scheme.

4. The ciphertext conversion system according to claim 3, wherein the processing circuitry of the conversion key generation device generates the conversion key with using the first common-key cryptographic information and second common-key cryptographic information which consists of the second secret key and second auxiliary information which are used in encryption according to the block-cipher counter mode scheme.

5. The ciphertext conversion system according to claim 4, wherein the processing circuitry of the conversion key generation device calculates, as the conversion key, an exclusive OR of a result of execution of the first common-key cryptography scheme with using the first common-key cryptographic information and a result of execution of the first common-key cryptography scheme with using the second common-key cryptographic information.

6. The ciphertext conversion system according to claim 4, further comprising:
a decryption device comprising
processing circuitry
to decrypt the attribute-based ciphertext with using a user secret key that matches attribute information corresponding to the attribute-based encryption key, thereby acquiring the attribute-based encryption key,
to decrypt the third common-key ciphertext with using the acquired attribute-based encryption key, thereby acquiring the second secret key, and
to find, as the plaintext, an exclusive OR of a result of encrypting the second auxiliary information with using the second secret key, and the second common-key ciphertext.

7. The cipher text conversion system according to claim 5, further comprising:
a decryption device comprising
processing circuitry
to decrypt the attribute-based ciphertext with using a user secret key that matches attribute information corresponding to the attribute-based encryption key, thereby acquiring the attribute-based encryption key,
to decrypt the third common-key ciphertext with using the acquired attribute-based encryption key, thereby acquiring the second secret key, and
to find, as the plaintext, an exclusive OR of a result of encrypting the second auxiliary information with using the second secret key, and the second common-key ciphertext.

8. The ciphertext conversion system according to claim 1, further comprising:
a conversion device comprising
processing circuitry to calculate, as the second common-key ciphertext, an exclusive OR of the first common-key ciphertext and the conversion key.

9. The ciphertext conversion system according to claim 2, further comprising:
a conversion device comprising
processing circuitry to calculate, as the second common-key ciphertext, an exclusive OR of the first common-key ciphertext and the conversion key.

10. The ciphertext conversion system according to claim 3, further comprising:
a conversion device comprising
processing circuitry to calculate, as the second common-key ciphertext, an exclusive OR of the first common-key ciphertext and the conversion key.

11. The ciphertext conversion system according to claim 4, further comprising:
a conversion device comprising
processing circuitry to calculate, as the second common-key ciphertext, an exclusive OR of the first common-key ciphertext and the conversion key.

12. The ciphertext conversion system according to claim 5, further comprising:
a conversion device comprising
processing circuitry to calculate, as the second common-key ciphertext, an exclusive OR of the first common-key ciphertext and the conversion key.

13. The ciphertext conversion system according to claim 6, further comprising:
a conversion device comprising
processing circuitry to calculate, as the second common-key ciphertext, an exclusive OR of the first common-key ciphertext and the conversion key.

14. The ciphertext conversion system according to claim 7, further comprising:
a conversion device comprising
processing circuitry to calculate, as the second common-key ciphertext, an exclusive OR of the first common-key ciphertext and the conversion key.

15. A conversion key generation method comprising:
generating an attribute-based encryption key and an attribute-based ciphertext which is encrypted from the attribute-based encryption key, according to an attribute-based encryption scheme;
generating a conversion key which converts a first common-key ciphertext into a second common-key ciphertext being a ciphertext that matches a first common-key cryptography scheme and that is different from the first common-key ciphertext, on a basis of first common-key cryptographic information used when generating the first common-key ciphertext by encrypting, according to the first common-key cryptography scheme, a plaintext with a first secret key; and
generating a third common-key ciphertext according to a second common-key cryptography scheme, by encrypting a second secret key used for decrypting the second common-key ciphertext, with the attribute-based encryption key.

16. A non-transitory computer readable medium storing a conversion key generation program which causes a conversion key generation device being a computer, to execute:
a conversion destination setting process of generating an attribute-based encryption key and an attribute-based ciphertext which is encrypted from the attribute-based encryption key, according to an attribute-based encryption scheme; and
a conversion key generation process of
generating a conversion key which converts a first common-key ciphertext into a second common-key ciphertext being a ciphertext that matches the first common-key cryptography scheme and that is different from the first common-key ciphertext, on a basis of first common-key cryptographic information used when generating the first common-key ciphertext by encrypting, according to a first common-key cryptography scheme, a plaintext with a first secret key, and
generating a third common-key ciphertext according to a second common-key cryptography scheme by encrypting a second secret key used for decrypting the second common-key ciphertext, with the attribute-based encryption key.
